(19) United States
(12) Patent Application Publication
(10) Pub. No.: US 2019/0182792 A1
(43) Pub. Date: Jun. 13, 2019

(54) NETWORK CONNECTION CONTROL METHOD BY USING A USER CONTEXT

(71) Applicant: INDUSTRY-UNIVERSITY COOPERATION FOUNDATION SOGANG UNIVERSITY, Seoul (KR)

(72) Inventors: Ju-Wook JANG, Seoul (KR); Hong Jin KIM, Seoul (KR)

(73) Assignee: INDUSTRY-UNIVERSITY COOPERATION FOUNDATION SOGANG UNIVERSITY, Seoul (KR)

(21) Appl. No.: 16/310,639

(22) PCT Filed: Apr. 28, 2017
(86) PCT No.: PCT/KR2017/004545

§ 371 Date: Dec. 17, 2018

(30) Foreign Application Priority Data
Aug. 24, 2016 (KR) 10-2016-0107843

(51) Int. Cl. H04W 64/00; H04W 48/16; H04W 76/10; H04W 48/18

(52) U.S. Cl. CPC H04W 64/00; H04W 48/18; H04W 76/10; H04W 48/16

(57) ABSTRACT

Provided is a network connection control method based on a user context including: collecting a sensing data including an external noise at every predetermined period, determining a user situation by using the sensing data, and recording information on the user situation in user context information; and selectively connecting a predetermined network so as to correspond to the user situation among a plurality of wireless networks every time when the user context information is changed.

### TECHNICAL FIELD

The present invention relates to a network connection technology of a user terminal, and more particularly, to a network connection control method based on a user context and a user terminal therefor.

### BACKGROUND ART

WI-FI (Wireless Fidelity) is a wireless local area network and is faster than 3G communication network in data processing speed. In general, WI-FI requires no separate communication fee or is cheaper than a cellular communication network in the related art although a fee is charged according to a policy. Therefore, WI-FI can allow a user terminal to be used more smartly. The user terminal is a smart mobile phone, a tablet PC, or a notebook PC.

More specifically, a user terminal capable of using a WI-FI searches for an access point (AP) that provides a WI-FI service and connects to a wireless data network. To this end, for example, there are two methods of searching for the AP. The first method is a method in which a user activates manually WI-FI to search for and connect to an accessible AP. The second method is a method of executing an application program of automatically searching for a WI-FI AP.

Such an application program can reduce the inconvenience of connection by a manual operation of a user at the time of using the WI-FI, and thus, the use amount thereof is gradually increasing.

However, since the application program periodically turns on the WI-FI function of the terminal to search for the AP, the use amount of the battery power of the user terminal is increased, and thus, there is a problem in that the battery use time of the terminal is decreased.

A method for solving such a problem is disclosed in Korean Patent Application Publication No. 10-2014-0085024, entitled “Terminal Device Usable in Cellular Network and WI-FI Network and Method for Performing Data Service” in Korean Patent Office. This technology discloses a terminal usable in a cellular network and a WI-FI network, including: a WI-FI module that is activated by control by a control module, searches one or more accessible access points (AP), and is connected to the selected AP according to the control so as to perform a data service; a location confirmation module that confirms a current location of the terminal; a memory module that stores or update-stores location-based AP information according to the control by the control module; and the control module that generates or updates the location-based AP information including information of the AP connected to the WI-FI module based on the terminal location confirmed by the location confirmation module, compares the current terminal position confirmed by the location confirmation module to the stored location-based AP information in the event of a data service request following user input in a WI-FI non-activation state, activates the WI-FI module for connection to the matching-successful AP and data service initiation in the event of successful matching within a tolerance as a result of the comparison, and activates the cellular network in the event of matching failure or inactivates the WI-FI module and activates the cellular network for data service initiation in the event of AP connection failure of the WI-FI module after matching success.

As described above, in the related art, one of the WI-FI network and the cellular communication network is selectively connected on the basis of the location of the user terminal to provide a data service.

However, as public WI-FI services are greatly expanded, the public WI-FI services are offered on subways and buses. Thus, in the related art based on only the location of the user terminal, there is a limitation in terms of efficiency.

### SUMMARY OF THE INVENTION

### Technical Problem

An object of the present invention is to provide a network connection control method based on a user context and a user terminal therefor, capable of allowing a user to use an economical, fast data providing service by generating user context information by determined a user situation on the basis of a change in a current location, an ambient noise, and the like and selectively connecting one of a plurality of wireless networks according to the user context information.

### Solution to Problems

According to an aspect of the present invention, there is provided a network connection control method based on a user context, including: collecting a sensed data including an external noise at every predetermined period, determining a user situation by using the sensing data, and recording information on the user situation in user context information; and selectively connecting a predetermined network so as to correspond to the user situation among a plurality of wireless networks every time when the user context information is changed.

### Effects of the Invention

According to the present invention, it is possible to obtain an effect of enabling a user to use an economical, fast data service in a communication network by generating user context information by determined a user situation on the basis of a change in a current location, an ambient noise, and the like and selectively connecting one of a plurality of wireless networks according to the user context information.

### BRIEF DESCRIPTION OF DRAWINGS

FIG. 1 is a schematic flow diagram of a network connection control method based on a user context according to a preferred embodiment of the present invention.

FIG. 2 is a configuration diagram of a user terminal according to a preferred embodiment of the present invention.

FIGS. 3 to 9 are flowcharts of a network connection control method based on a user context according to a preferred embodiment of the present invention.

### BEST MODE FOR CARRYING OUT THE INVENTION

According to the present invention, it is possible to enable a user to use an economical and fast data service in a communication network by generating user context information by determined a user situation on the basis of a change in a current location, an ambient noise, and a user's motion and selectively connecting one of a plurality of wireless networks according to the user context information.

A network connection control method based on a user context according to a preferred embodiment of the present invention will be described in detail with reference to the drawings.

<Schematic Procedure of Network Connection Control Method Based on User Context>

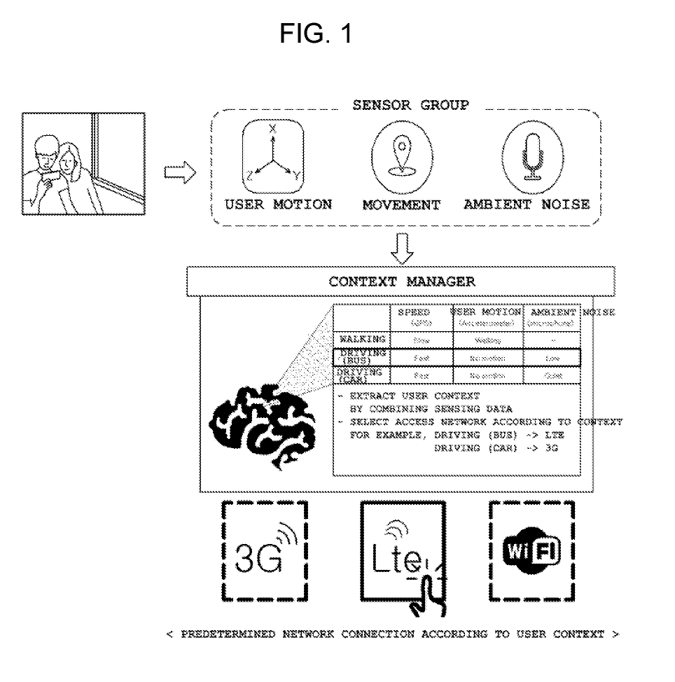

A schematic procedure of a network connection control method based on a user context according to the preferred embodiment of the present invention will be described with reference to FIG. 1.

According to the preferred embodiment of the present invention, a user terminal is provided with a sensor group including an acceleration sensor, a GPS reception module, a microphone, and the like for sensing a user motion, a movement, an ambient noise, and the like, respectively.

A context manager, which is an application program installed and executed in the user terminal, receives a sensing data through the sensor group, generates a user context indicating a user state, and connects a predetermined network based on a user context. Thus, the user terminal can maximize the convenience of the user by automatically connecting a network that can give an economical and fast data service to the user.

<Configuration of User Terminal>

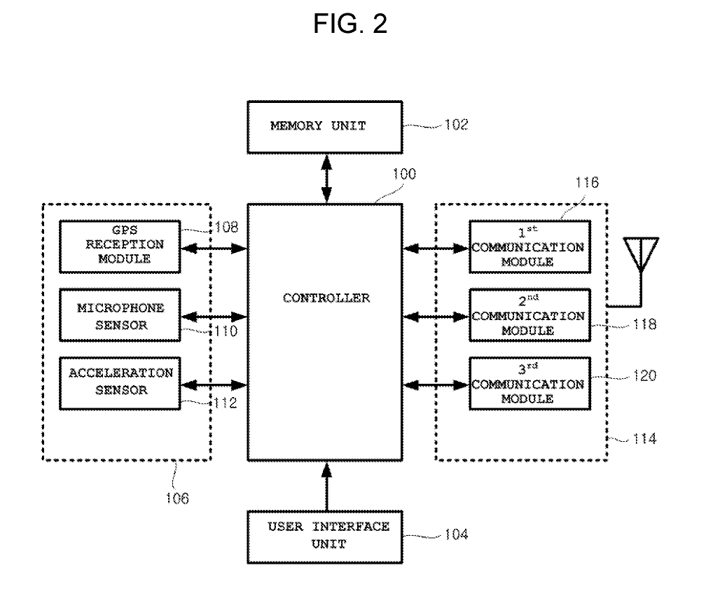

A configuration of a mobile terminal of a user according to the preferred embodiment of the present invention will be described with reference to FIG. 2.

The mobile terminal of the user is configured to include a controller 100, a memory 102, a user interface unit 104, a sensor group 106, and a communication unit 114.

The controller 100 controls each component of the mobile terminal of the user and functions as a context manager according to the preferred embodiment of the present invention.

The memory 102 stores various types of information including a control program of the controller 100 and, particularly, stores reference information for network connection control according to the preferred embodiment of the present invention.

The user interface unit 104 provides interface between user and the controller and supplies various types of information input from the user to the controller 100.

The sensor group 106 is configured to include a GPS reception module 108, a microphone sensor 110 and an acceleration sensor 112. The GPS reception module 108 receives GPS information, calculates a current location, and supplies the current location to the controller 100. The microphone sensor 110 senses external noise and supplies the external noise information to the controller 100. The acceleration sensor 112 senses an acceleration change and supplies the acceleration change information to the controller 100.

The communication unit 114 is configured to include first to third communication modules 116 to 120. Each of the first to third communication modules 116 to 120 connects the controller 100 and each of a first cellular network, a second cellular communication network, and a wireless Internet network, and the like.

<Procedure of Network Connection Control Method Based on User Context>

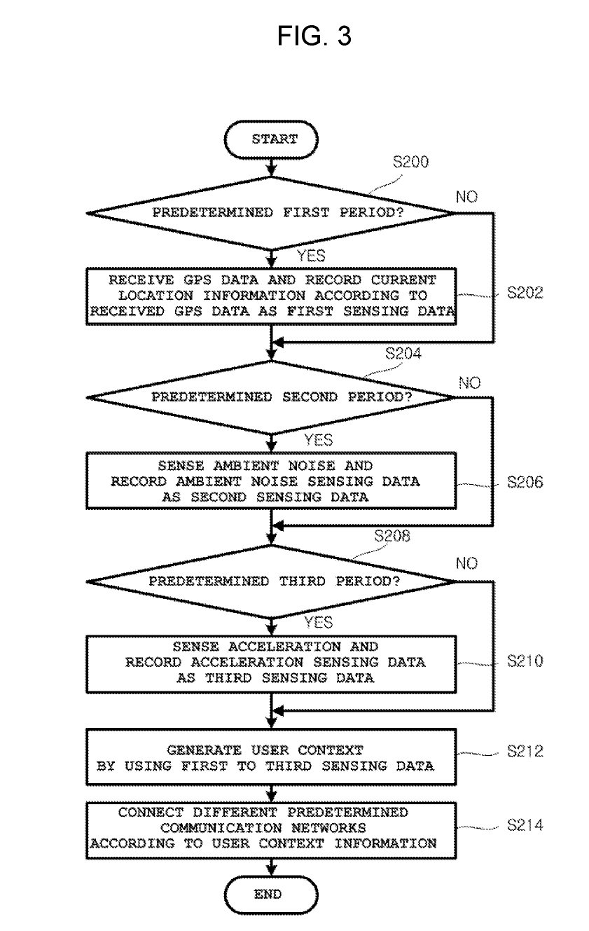

A procedure of the network connection control method based on the user context according to the present invention described above will be described with reference to FIG. 3.

The controller 100 of the user terminal receives GPS data through the GPS reception module 108 every predetermined first period and records current location information corresponding to the received GPS data as a first sensing data (steps 200 and 202).

The controller 100 of the user terminal senses external noise through the microphone sensor 110 every predetermined second period and records an external noise sensing data as a second sensing data (steps 204 and 206).

The controller 100 of the user terminal senses the acceleration through the acceleration sensor 112 every predetermined third period and records an acceleration sensing data as a third sensing data (steps 208 and 210).

Then, the controller 100 generates user context information by using the first to third sensing data and accesses the communication network which is set differently based on the user context information (steps 212 and 214).

As described above, according to the present invention, the user context information indicating a user situation by using a sensing data on a GPS data, an external noise, and acceleration is generated, and an appropriately predetermined communication network is selectively connected according to the user context information.

Particularly, the user situations that can determine by using the sensing data of the GPS data, the external noise, and the acceleration are a bus boarding state, a walking state, a car boarding state, a subway boarding state, a located-in-building state, and the like.

Hereinafter, the process of determining the user situation will be described in more detail with respect to each of the bus boarding state, the walking state, the car boarding state, the subway boarding state, the located-in-building state, and the underground driving state.

<Bus Boarding State>

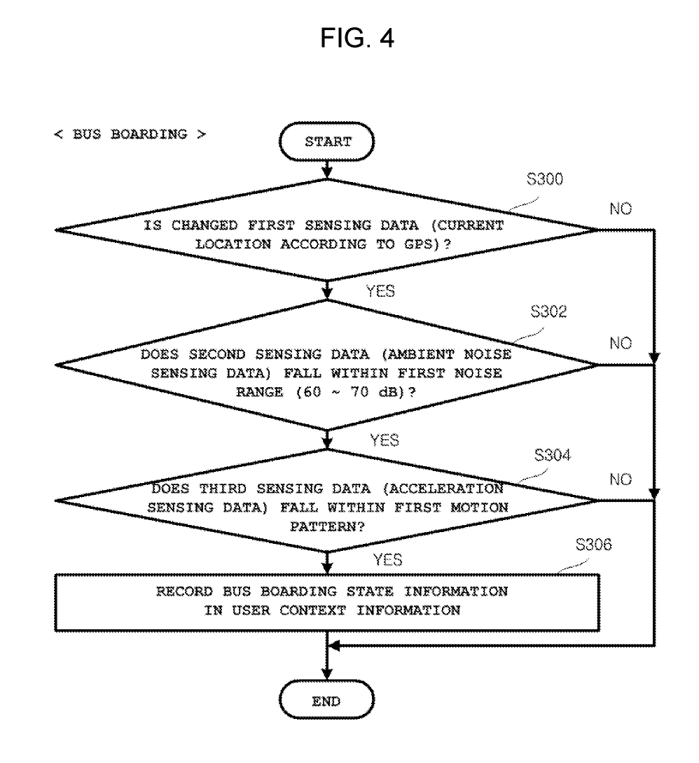

First, a process of determining the bus boarding state will be described with reference to FIG. 4.

The controller 100 of the user terminal checks whether or not the first sensing data, that is, the current location according to GPS is changed (step 300).

When the first sensing data is changed, the controller 100 checks whether or not the second sensing data, that is, the external noise sensing data falls within the first noise range (60 to 70 dB), which is an external noise range in a relatively very noisy place (step 302).

If the first sensing data is changed and if the second sensing data falls within the first noise range (60 to 70 dB), the controller 100 checks whether or not the third sensing data has the first motion pattern (step 304). In the first motion pattern, the change amount of the acceleration sensing data in the X and Z axes may fall within a relatively large first change amount range, and the change amount in the Y axis may fall within a relatively small second change amount range.

When the first sensing data is changed, the second sensing data falls within the first noise range (60 to 70 dB), and the third sensing data falls within the first motion pattern, the controller 100 determines the user state as the bus boarding state and records the bus boarding state information in the user context information (step 306).

<Walking State>

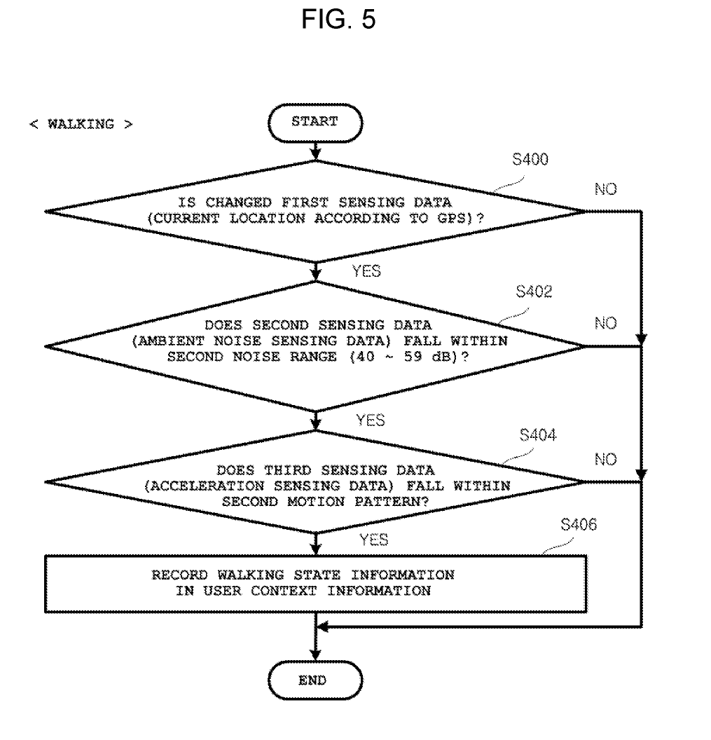

First, a process of determining the walking state will be described with reference to FIG. 5.

The controller 100 of the user terminal checks whether or not the first sensing data, that is, the current location according to GPS is changed (step 400).

If the first sensing data is changed, the controller 100 checks whether or not the second sensing data, that is, the external noise sensing data falls within the second noise range (40 to 59 dB), which is an external noise range in a relatively noisy place (step 402).

If the first sensing data is changed and if the second sensing data falls within the second noise range (40 to 59 dB), the controller 100 checks whether or not the third sensing data falls within the second motion pattern (step 404). In the second motion pattern, the change amount of the acceleration sensing data in the X and Z axes may fall within a relatively large first change amount range, and the change amount in the Y axis may fall within a relatively large third change amount range.

When the first sensing data is changed, if the second sensing data falls within the second noise range (40 to 59 dB), and if the second sensing data falls within the second motion pattern, the controller 100 determines the user state to be the walking state and records the bus boarding state information in the user context information (step 406).

<Car Boarding State>

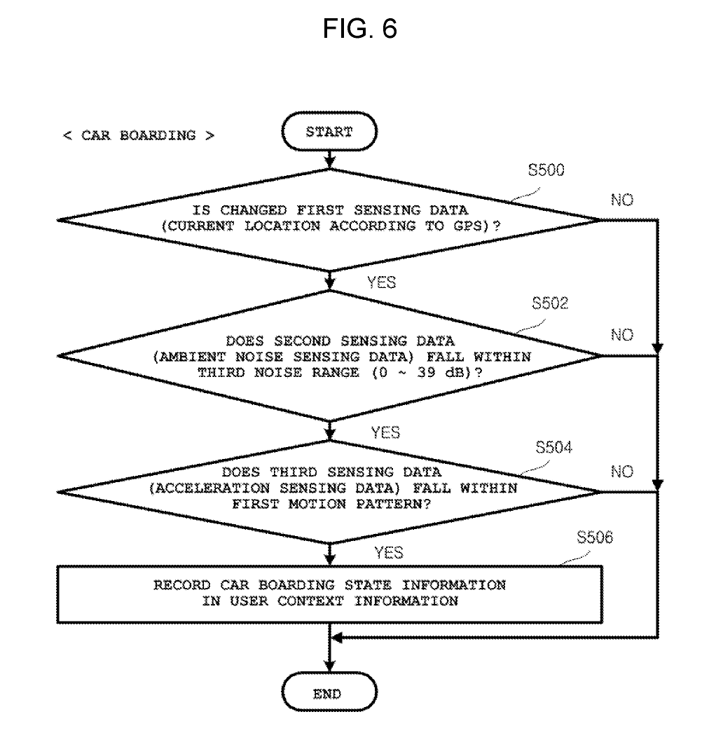

First, a process of determining the car boarding state will be described with reference to FIG. 6.

The controller 100 of the user terminal checks whether or not the first sensing data, that is, the current location according to GPS is changed (step 500).

If the first sensing data is changed, the controller 100 checks whether or not the second sensing data, that is, the external noise sensing data, falls within the third noise range (0 to 39 dB), which is an external noise range in a relatively quiet place (step 502).

If the first sensing data is changed and if the second sensing data falls within the first noise range (0 to 39 dB), the controller 100 checks whether or not the third sensing data falls within the first motion pattern (step 504).

If the first sensing data is changed, if the second sensing data falls within the third noise range (0 to 39 dB), and if the third sensing data falls within the first motion pattern, the controller (100) determines the user state to be the car boarding state and records the car boarding state information in the user context information (step 506).

<Subway Boarding State>

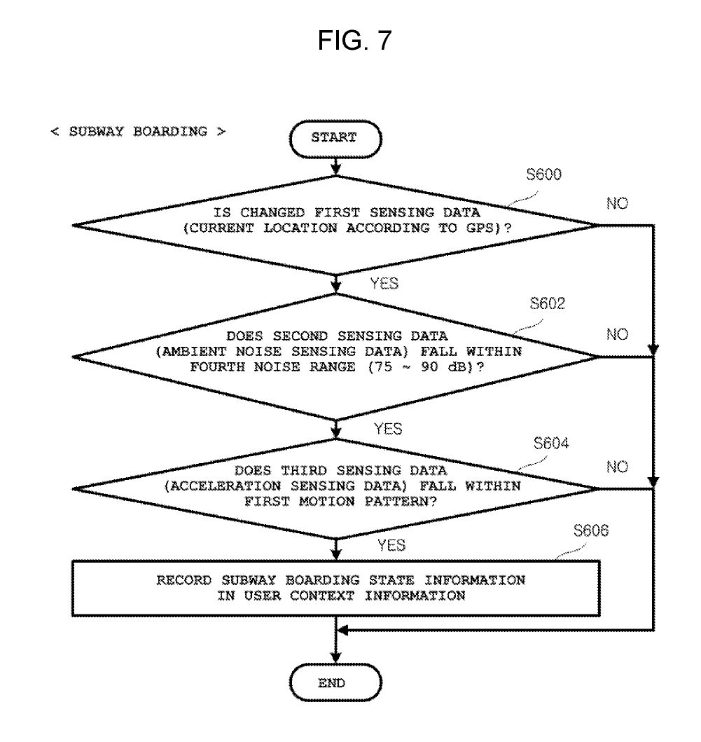

First, a process of determining the subway boarding state will be described with reference to FIG. 7.

The controller 100 of the user terminal checks whether or not the first sensing data, that is, the current location according to GPS is changed (step 600).

If the first sensing data is not changed, the controller 100 checks whether or not the second sensing data, that is, the external noise sensing data falls within the fourth noise range (75 to 90 dB), which is an external noise range in a relatively very noisy place (step 602).

If the first sensing data is not changed and if the second sensing data falls within the fourth noise range (75 to 90 dB), the controller 100 checks whether or not the third sensing data falls within the first motion pattern (step 604).

If the first sensing data is not changed, if the second sensing data falls within the fourth noise range (75 to 90 dB), and if the third sensing data falls within the first motion pattern, the controller (100) determines the user state to be the subway boarding state and records the subway boarding state information in the user context information (step 606).

<Located-In-Building State or Underground Driving State>

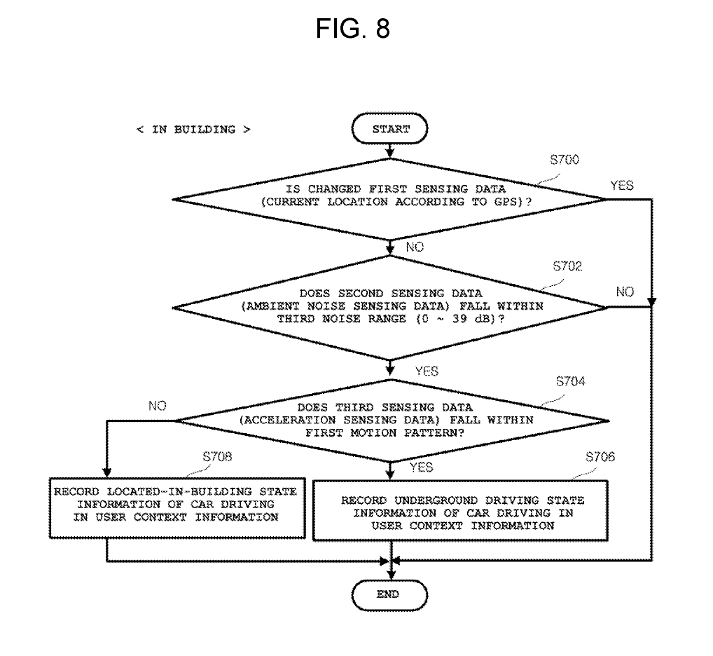

Now, a process of determining whether the user is located in a building or is driving underground in a car will be described with reference to FIG. 8.

The controller 100 of the user terminal checks whether or not the first sensing data, that is, the current location is changed according to GPS (step 700).

When the first sensing data is not changed, the controller 100 determines whether the second sensing data, that is, the external noise sensing data, falls within the third noise range (0 to 39 dB), which is an external noise range of a relatively quiet place (step 702).

When the first sensing data is not changed and the second sensing data falls within the first noise range (0 to 39 dB), the controller 100 checks whether or not the third sensing data falls within the first motion pattern (step 704).

When the first sensing data is not changed, the second sensing data falls within the third noise range (0 to 39 dB), and the third sensing data falls within the first motion pattern, the controller 100 determines the user state as a state that the user is driving underground while being in a car and records the underground driving state information in the user context information (step 706).

Alternatively, when the first sensing data is not changed, the second sensing data falls within the third noise range (0 to 39 dB), and the third sensing data does not fall within the first motion pattern, the controller 100 determines the user state as a state that the user is located in the building and records the located-in-building state information in the user context information (step 708).

Particularly, in order to accurately detect the user state, the user state may be determined as the located-in-building state only when the third sensing data does not fall within the first and second motion patterns.

<Network Connection>

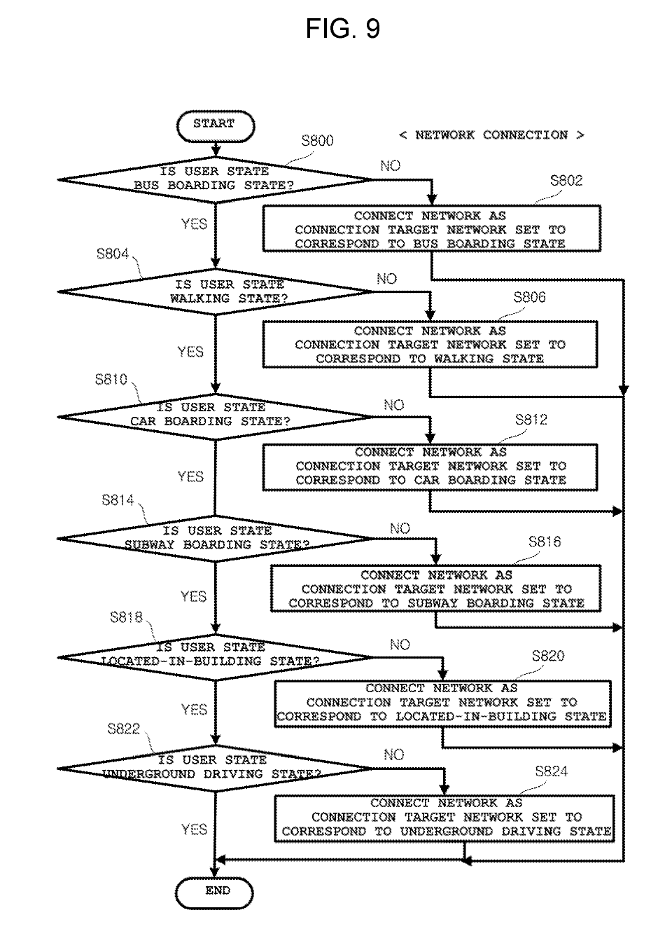

Now, a process of connecting a network according to the preferred embodiment of the pre sent invention will be described with reference to FIG. 9.

When the bus boarding state information is recorded in the user context information each time the user context information is updated, the controller 100 of the user terminal establishes the network connection to the connection target network set o as to correspond to the bus boarding state (steps 800 and 802).

Herein, since a public WI-FI service is provided for a public transportation such as a bus, a connection target network corresponding to the bus boarding state information may be wireless Internet.

Alternatively, when the walking state information is recorded in the user context information, the network connection is established to the connection target network so as to correspond to the walking state (steps 804 and 806). Herein, the connection target network set so as to correspond to the walking state, connects the network to the connection target network set so as to correspond to the current location according to the location-based network connection service.

Alternatively, when the car boarding state information is recorded in the user context information, the network connection is established to the connection target network set so as to correspond to the car boarding state (steps 808 and 810).

Herein, the established connection target network may be a cellular network so as to correspond to the car boarding state.

Alternatively, when the subway boarding state information is recorded in the user context information, the network connection is established to the connection target network set so as to correspond to the subway boarding state (steps 814 and 816).

Herein, since the public WI-FI service is provided for the public transportation such as the bus, the connection target network corresponding to the bus boarding state information may be a wireless Internet.

Alternatively, when the located-in-building state information is recorded in the user context information, the network connection is established to the connection target network set so as to correspond to the located-in-building state (steps 818 and 820).

Herein, the connection target network set so as to correspond to the located-in-building state connects the network to the connection target network set so as to correspond to the current location according to the location-based network connection service.

Alternatively, when the underground driving state information is recorded in the user context information, the network connection is established to the connection target network set so as to correspond to the underground driving state (steps 822 and 824).

Herein, the connection target network set so as to correspond to the underground driving state may be a cellular network.

1. A network connection control method based on a user context performed by a controller of a mobile device, comprising:
collecting peroidically a sensing data representing information on user's state, wherein the user is carrying the mobile device,
determining a user situation by using the sensing data,
recording information on the user situation in user context information; and
selectively connecting a predetermined network so as to correspond to the user situation among a plurality of wireless networks every time when the user context information is changed,
wherein the sensing data includes a location information of the mobile device, an ambient noise of the mobile device and an acceleration sensing data of the mobile device.

2. The network connection control method according to claim 1,
wherein the user situation is determined as a bus boarding state when current location is variable, a magnitude of the ambient noise is in a predetermined first range, and an acceleration sensing data of the predetermined first motion pattern is generated,
wherein the network corresponding to the bus boarding state is a wireless Internet network, and
wherein, in the first motion pattern, a change amount of acceleration in X and Z axes falls within a predetermined first change amount range, and a change amount of acceleration in a Y axis falls within a predetermined second change amount range.

3. The network connection control method according to claim 1,
wherein the user situation is determined as a subway boarding state when current location is not variable, a magnitude of the ambient noise is in a predetermined second range and the acceleration sensing data of the predetermined first motion pattern is generated,
wherein the network corresponding to the subway boarding state is a wireless Internet network, and
wherein, in the first motion pattern, a change amount of acceleration in X and Z axes falls within a predetermined first change amount range, and a change amount of acceleration in a Y axis falls within a predetermined second change amount range.

4. The network connection control method according to claim 1,
wherein the user situation is determined as a walking state when current location is variable, a magnitude of the ambient noise is in a predetermined third range, and the acceleration sensing data of the predetermined second motion pattern is generated,
wherein the network corresponding to the walking state is a network set in advance on the basis of location, and
wherein, in the predetermined second motion pattern, the change amount of acceleration in X, Y, and Z axes falls within a predetermined first change amount range.

5. The network connection control method according to claim 1,
wherein the user situation is determined as a car boarding state when a current location is variable, a magnitude of the ambient noise is in a predetermined fourth range, and the acceleration sensing data of the predetermined first motion pattern is generated,
wherein the network corresponding to the car boarding state is a cellular network, and
wherein, in the first motion pattern, a change amount of acceleration in X and Z axes falls within a predetermined first change amount range, and a change amount of acceleration in a Y axis falls within a predetermined second change amount range.

6. The network connection control method according to claim 1,
wherein the user situation is determined as an underground driving state when a current location is not variable, a magnitude of the ambient noise is in a predetermined fourth range, and the acceleration sensing data of the predetermined first motion pattern is generated,
wherein the network corresponding to the underground driving state is a cellular communication network, and
wherein, in the first motion pattern, a change amount of acceleration in X and Z axes falls within a predetermined first change amount range, and a change amount of acceleration in a Y axis falls within a predetermined second change amount range.

7. The network connection control method according to claim 1,
wherein the user situation is determined as an located-in-building state when the current location is not variable, a magnitude of the ambient noise is in a predetermined fourth range, and the acceleration sensing data of the predetermined first or second motion pattern is not generated,
wherein the network corresponding to the located-in-building state is a network set in advance on the basis of location,
wherein, in the first motion pattern, a change amount of acceleration in X and Z axes falls within a predetermined first change amount range, and a change amount of acceleration in a Y axis falls within a predetermined second change amount range, and
wherein, in the first motion pattern, the change amount of acceleration in X, Y, and Z axes falls within a predetermined first change amount range.

8. The network connection control method according to claim 1,
wherein the location information is calculated on the basis of a GPS data obtained from a GPS reception module of the mobile device, the acceleration sensing data is provided from an acceleration sensor of the mobile device, and the ambient noise is provided from a microphone sensor of the mobile device.

9. The network connection control method according to claim 1,
wherein the information on the user situation includes user's movement information, user's motion information and an ambient environment information; and
wherein the user's movement information is obtained from the location information, the user's motion information is obtained from the acceleration sensing data, and the ambient environment information is obtained from the ambient noise.
